(19) United States
(12) Patent Application Publication
(10) Pub. No.: US 2005/0035062 A1
(43) Pub. Date: Feb. 17, 2005

(54) Coated activated carbon for contaminant removal from a fluid stream

(76) Inventors: Laurence H. Hiltzik, Charleston, SC (US); Edward D. Tolles, Charleston, SC (US); David R. B. Walker, Lansdale, PA (US)

Correspondence Address: Terry B. McDaniel, 5255 Virginia Avenue, Post Office Box 118005, Charleston, SC, 29423-8005, US

(21) Appl. No.: 10/929,845

(22) Filed: Aug. 30, 2004

Related U.S. Application Data
(63) Continuation-in-part of application No. 10/287,493, filed on Nov. 5, 2002.
Application No. 10/287,493 is a continuation-in-part of application No. 09/448,034, filed on Nov. 23, 1999, now abandoned.

(51) Int. Cl. B01D 15/00

(52) U.S. Cl. 210/660

(57) ABSTRACT

Product attrition by dusting of granular and shaped activated carbons is disclosed to be reduced significantly, or essentially eliminated, by the application of a thin, continuous polymer coating on the granular or shaped activated carbon, without a reduction in adsorption velocity, packing density, or volumetric capacity of the activated carbon when used in fluid stream filters for removing contaminants. The avoidance of carbon dust and the maintenance of the carbon particle packing density lead to improved fluid stream filter performance in contaminant removal.

This application is a continuation-in-part application of Ser. No. 10/287,493 titled “Coated Activated Carbon For Contaminant Removal From A Fluid Stream,” by L. H. Hiltzik, E. D. Tolles, and D. R. B. Walker, filed on Nov. 5, 2002, which is a continuation-in-part application of Ser. No. 09/448,934 titled “Coated Activated Carbon,” by L. H. Hiltzik, E. D. Tolles, and D. R. B. Walker, filed on Nov. 23, 1999, now abandoned.

### BACKGROUND OF THE INVENTION

1. Field of the Invention

This invention relates to activated carbon pellets and activated granules with improved dusting characteristics for contaminant removal from a fluid stream without affecting its dynamic performance on a volume-filter basis. In particular, this invention relates to activated carbons susceptible to dust attrition due to abrasion where dusting can result in loss of product and often cause other problems related to its use in contaminant removal from drinking water.

2. Description of Related Art (Including Information Disclosed Under 37 CFR 1.97 and 37 CFR 1.98

Active carbon long has been used for removal of impurities and recovery of useful substances from liquid and gas fluid streams because of its high adsorptive capacity. Generally, “activation” refers to any of the various processes by which the pore structure is enhanced. Typical commercial activated carbon products exhibit a surface area (as measured by nitrogen adsorption as used in the B.E.T. model) of at least 300 m²/g. For the purposes of this disclosure, the terms “active carbon” and “activated carbon” are used interchangeably. Typical activation processes involve treatment of carbon sources, such as resin wastes, coal, coal coke, petroleum coke, lignites, polymeric materials, and lignocellulosic materials including pulp and paper, residues from pulp production, wood (like wood chips, sawdust, and wood flour), nut shell (like almond shell and coconut shell), kernel, and fruit pits (like olive and cherry stones) either thermally (with an oxidizing gas) or chemically (usually with phosphoric acid or metal salts, such as zinc chloride).

Chemical activation of wood-based carbon with phosphoric acid (H₃PO₄) is disclosed in U.S. Pat. No. Re. 31,093 to improve the carbon's decolorizing and gas adsorbing abilities. Also, U.S. Pat. No. 5,162,286 teaches phosphoric acid activation of wood-based material which is particularly dense and which contains a relatively high (30%) lignin content, such as nut shell, fruit stone, and kernel. Phosphoric acid activation of lignocellulose material also is taught in U.S. Pat. No. 5,204,310 as a step in preparing carbons of high activity and high density.

Also, U.S. Pat. No. 4,769,359 teaches producing active carbon by treating coal cokes and chars, brown coals or lignites with a mixture of NaOH and KOH and heating to at least 500 EC in and inert atmosphere. U.S. Pat. No. 5,102,855 discloses making high surface area activated carbon by treating newspapers and cotton linters with phosphoric acid or ammonium phosphate. Coal-type pitch is used as a precursor to prepare active carbon by treating with NaOH and/or KOH in U.S. Pat. No. 5,143,889.

Once the activated carbon product is prepared, however, it may be subject to some degradation before and during its use. Abrading during materials handling and actual use of such activated carbon results in loss of material in the form of dust. Such “dusting” of the product is a function of its relative hardness and its shape, as well as how it is handled in the plant, in moving it into and out of plant inventory, in loading for transport and in off-loading by the receiver, and in how it is handled by the receiver to place the product into use. In certain applications, where the activated carbon is subject to vibration or erosion, product degradation by dusting continues through the life of the product.

The dust in a carbon bed is a nuisance in that it has the potential to contaminate the fluid stream being treated, to increase flow resistance of the filter device by clogging the bed and downstream particulate filters, and to disrupt the uniform flow of fluid through the bed by creating high flow restriction “dead zones.” Therefore, means to eliminate dusting of carbon during filter assembly and during filter use are highly valued.

Furthermore, when the activated carbon is used in the form of a packed bed, it is important for the packing of particles in the bed to remain intact after filling. Changes in packing density may lead to nonuniform flow through the bed when nonuniformly distributed voidages in the bed are created. For many uses of carbon filters, it is highly desired to obtain a “dense packing” of adsorbent when manufacturing the filter in order to reduce the size of the filter where space is at a premium or a compact size is highly valued, to eliminate the potential for volume changes in the bed during transport or use, and to reduce the cost of materials by making the filter volume as small as possible for the desired level of contaminant removal and for the desired performance lifetime. The highest amount of carbon per unit volume of bed, or “dense packing,” is obtained by a method of filling particles into a container at a sufficiently slow rate, such as defined by the ASTM method D-2854, as to allow individual particles to settle into the forming bed, unencumbered by adjacent settling particles. Another means for achieving dense packing is by agitating a filled bed with an appropriate vibrational frequency and amplitude to promote particle settling. Once a dense packing has been achieved, elaborate means have been devised in order to maintain packing density in activated carbon filters and to keep the bed packing unchanged during use, such as taught by U.S. Pat. Nos. 4,766,872, 5,098,453, and 6,551,388. In any event, it as advantageous to minimize any bed settling or volume change after the filter is manufactured in order to assure uniform flow resistance of the treated fluid through the particulate bed and to maximum volumetric performance of the filter device for contaminant removal.

The hardness of an activated carbon material is primarily a function of the hardness of the precursor material, such as a typical coal-based activated carbon being harder than a typical wood-based activated carbon. The shape of granular activated carbon also is a function of the shape of the precursor material. The irregularity of shape of granular activated carbon, i.e., the availability of multiple sharp edges and corners, contributes to the dusting problem. Of course, relative hardness and shape of the activated carbon are both subject to modification. For example, U.S. Pat. Nos. 4,677,086, 5,324,703, and 5,538,932 teach methods for making pelleted products of high density from lignocellulosic precursors. Also, U.S. Pat. No. 5,039,651 teaches a method of producing shaped activated carbon from cellulosic and starch precursors in the form of “tablets, plates, pellets, briquettes, or the like.” Further, U.S. Pat. No. 4,221,695 discloses making an “Adsorbent for Artificial Organs” in the form of beads by mixing and dissolving petroleum pitch with an aromatic compound and a polymer or copolymer of a chain hydrocarbon, dispersing the resultant mixture in water giving rise to beads, and subjecting these beads to a series of treatments of removing of the aromatic hydrocarbon, infusibilizing, carbonizing, and finally activating.

Despite these and other methods of affecting activated carbon hardness and shape, however, product dusting continues to be a problem in certain applications. For example, in U.S. Pat. No. 4,221,695, noted above, the patentees describe conventional beads of a petroleum pitch-based activated carbon intended for use as the adsorbent in artificial organs through which the blood is directly infused that are not perfectly free from carbon dust. They observe that some dust steals its way into the materials in the course of the preparation of the activated carbon, and some dust forms when molded beads are subjected to washing and other treatments. The patentees reflected conventional wisdom in noting that the application of a film-forming substance to the surface of the adsorbent “is nothing to be desired,” because the applied substance acts to reduce the adsorption velocity of the matters to be adsorbed on the adsorbent and limit the molecular size of such matters being adsorbed.

Subsequently, however, in U.S. Pat. No. 4,476,169, the patentees describe a multi-layer glass window wherein vapor between the glass sheets is adsorbed by a combination of a granular zeolite with granular activated carbon having its surface coated with 1-20 wt % synthetic resin latex, including styrene- and nitrile-based polymers. The coating of the activated carbon is described as greatly inhibiting the occurrence of dust without substantially reducing the absorptive power of activated carbon for an organic solvent. The limitation of the invention is that it does not consider the effects of the coating on the packing properties of the particles or the rates of vapors transport across the coating and within the particles, or commonly referred to as adsorption “speed” or “kinetics.” Adsorption by the coated activated carbon particles is only compared on an equilibrium weight-sample basis, and not on a volume packed bed basis. There was also no consideration of whether the polymer coatings on the activated carbons would hinder vapor transport between the bulk phase and the activated carbon interior. While packing density and adsorption kinetics may not be critical for a near-equilibrium application like the removal of residual sealant solvents in a multipane window for reducing local dew points of contaminants, packing density and transport kinetics are important performance factors for packed bed activated carbon filter applications, such as point-of-use water filters, gas masks, and evaporative fuel emission control canisters in internal combustion engine vehicles. For packed bed filter applications used for treatment of fluids under flow rather than static conditions, the consequence of hindered transport of vapors between the bulk fluid phase and the activated carbon interior is a lengthening of the mass transfer zone where active adsorption takes place in the bed. The consequence of the lengthened mass transfer zone is premature breakthrough of contaminant vapors in the outlet or exhaust of the filter, and is undesirable for these filter applications.

The present invention relates to the discovery that activated carbon, granular or pelletized, can be coated to reduce dust that is a nuisance in contaminant removal from fluid streams, and particularly in point-of-use (POU) water treatment applications, or other fluid treatment applications, where the activated carbon is used in the form of a packed bed of granules or pellets and the kinetic rate of vapor transport needs to be unhindered by the presence of the coating film. The volumetric performance of the packed bed for contaminant removal is maintained by a coating that causes no significant decrease in dynamic adsorptive performance for POU water filter applications, as measured by chlorine removal performance, and causes essentially no reduction in particle packing within the bed.

Additionally, activated carbon can be colored by applying pigment and binder to either coated or uncoated activated carbon. Insoluble pigments, rather than soluble dyes, are preferred since soluble dyes are adsorbed by activated carbon yielding a black product that leaches color afterwards as the dye desorbs. Colored coatings may also be used to provide a functional indicator to show when a carbon filter is spent. Colored coatings can be applied for aesthetic purposes, such as for carafe type filters, so that the activated carbon is not black. Different colors can provide an effective means of differentiating between different activated carbon grades, such as grades for chlorine removal and grades for chloramine removal. Also, color can be used to identify the year of manufacture, quality assurance, and/or brand identification. For example, a water filter manufacturer could demand a red activated carbon filter media to assure that some other manufacturer's activated carbon is not used in its place.

### BRIEF DESCRIPTION OF THE DRAWINGS

FIG. 1 is a graphical representation of the effect of the coefficient of static friction properties of coating polymers on the packing density of coated activated carbon (the amount of activated carbon weight in a unit volume of dense-packed bed relative to the amount of carbon in a packed bed of uncoated activated carbon), with the data as reported in Table I.

FIG. 2 is a graphical representation of the fines content as a function of polyethylene coating content for 10×20 mesh coated activated carbon.

FIG. 3 is a graphical representation of chlorine removal by 2% polyethylene coated and uncoated 10×20 mesh activated carbons used in a packed bed column filter.

### SUMMARY OF THE INVENTION

It has been discovered that product attrition by dusting of granular and shaped activated carbons can, in fact, be reduced significantly, or essentially eliminated, by the application of a thin, continuous polymer coating on the granular or shaped activated carbon. Furthermore, by appropriate selection of the coating polymer, the elimination of dusting can be obtained without a reduction in adsorption velocity or volumetric capacity of the activated carbon for contaminant removal from a fluid stream.

The avoidance of attrited carbon dust leads to improved chlorine removal performance in water filtration. Manufacturers of filters used to remove contaminants from fluid streams often direct users to flush carbon filters of dust before a filter is put into service. Dust issues have led some manufacturers to use carbon blocks instead of granular carbon. Ideally, a coated carbon would not require flushing and would have the same adsorptive and/or removal performance as an uncoated carbon. Though undesirable, filter manufacturers may even accept a slight reduction in performance in exchange for reduction of dust. Chlorine removal (from water) testing shows that significant dust reduction is possible with little to no loss in chlorine removal efficacy.

A method is disclosed based on applying a visible polymer coating on the finished product and then removing any residual dust. The product is considered dust free, as shown by an “initial dust” value of ≦0.3 mg/dL and a “dust rate” value of ≦0.01 mg/min/dL, both below the detection limits of the standard dust attrition test. The product is “essentially” dust free, as shown by a “dust rate” value of ≦0.06 mg/min/dL, a detectable value but dramatically lower than the dust rate of uncoated activated carbon and, as noted in the tables which follow in the examples below, is the highest dust rate value of the invention-treated activated carbons.

An additional feature is that this coating provides the activated carbons with a glossy and attractive appearance that calls attention to product cleanliness. The glossy nature of the coating results from the film-forming nature of the polymer and the emulsion form by which it is applied to the pellets. An added facility, and possible benefit, provided by the invention composition and process is achieved by the natural color of the coating material or by the addition of coloring agents, such as pigments and optical brighteners, to the polymer emulsion. In particular, distinct carbon products may be identified through color-coding. The color-coding may relate to product application, plant origination, customer designation, or any designation desired.

The difference in appearance between the invention emulsion coated glossy pellets and previous dispersion-coated pellets is due to the different forms of the polymers used in applying the coatings. The particle sizes of emulsions are smaller than dispersions, therefore emulsions form continuous films due to the effects of capillary forces when dried of the carrier liquid. Dispersions do not form continuous films by drying, and they leave behind discrete (i.e., noncontinuous) polymer particles similar in size to the originally dispersed particles. The continuous, emulsion-applied polymer film, on the other hand, provides a glossy appearance, coating integrity, pellet dust reduction, and hydrophobicity that a dispersion-applied, non-continuous film does not.

Also, it should be noted that while the polymer film resulting from the application of the polymer emulsion onto the shaped or granular carbon is a continuous film, it may be porous or non-porous, depending on the irregularity of surface shape of the carbon material. The appearance of a porous continuous film occurs more often on the more irregular shaped granular activated carbons than on shaped activated carbons.

A variety of colored carbons can be prepared by choosing the proper combination of pigments for addition to the polymer emulsion and the emulsion application methods, as taught in the foregoing examples, in order to attain the desired color, plus obtain the desired benefits of the coating.

The process for essentially eliminating dust attrition of activated carbon material by coating the activated carbon material comprising the steps of:
(a) spraying an emulsion of the polymer onto exposed surfaces of the activated carbon material while it is in a state of turbulence; and
(b) drying the coated activated carbon material.

The process may optionally include an initial step of preheating the active carbon material to above ambient temperature. The process may include multiple repetitions of steps (a) and (b). Also, the process of the claimed invention may comprise a further step
(c) de-dusting the dried coated activated carbon material by removing any residual dust therefrom.

As those skilled in the art appreciate, various processing conditions are generally interdependent, such as processing time and processing temperature. These operating conditions as well may depend on the nature of the carbon material to be coated (shaped or granular, coal-based or lignocellulosic-based, etc.) and the coating material (relative volatility, viscosity, etc.). Thus, the temperature range for coating application and coating drying steps may range from just below ambient of about 50° F., up to about 280° F. (138° C), and the processing time may take from about 1 minute to about 12 hours. For most combinations of shaped or granular active carbon material and coating material, a preferred operating temperature range for the coating and drying steps is from about 70° F. (21° C.) to about 250° F. (121° C.) for from about 5 minutes to about 6 hours.

The turbulent state of the active carbon material can be induced by various known means. For example, the carbon material, in granular or shaped (usually pellet) form, may be placed in a rotary tumbler, in a mixing device, or on a fluidized bed. While it is critical that the active carbon material be in a kinetic, rather than static, state when the coating material is applied to assure relatively even coating on the external surface area of the active carbon material, it is not critical how the kinetic state is achieved.

The coating materials useful in the claimed invention are those capable of forming a continuous film. In particular, polymers, copolymers, and polymer blends that are suitable coating materials include those which have demonstrated adequate “slip” properties, such as polyethylene, which thereby do not impair particle packing density. It has been discovered that the polymer films of choice on the external surface of the activated carbon particle leave packing density essentially unaffected compared with the uncoated particles and have a coefficient of static friction (‘CSF’) of less than 0.3. The CSF relates to the force required to initiate movement between two surfaces and is, specifically, the ratio of the frictional force resisting the initial movement for the surface being tested to the force applied normal to the surface. The CSF is measured as the tangent of angle of inclination at which sliding occurs between two surfaces as the surfaces are inclined from level [CSF=tan(“slide angle”)]. For prospective polymer emulsions to be used in coating activated carbon, the CSF of the polymer is determined by first preparing a draw-down film of the emulsion, such as according to ASTM procedure D 823 “Standard Practices for Producing Films of Uniform Thickness of Paint, Varnish, and Related Products on Test Panels: Practice C—Motor-Driven Blade Film Application,” and then conducting the CSF measurement, as described in “The Standard Method for Coefficient of Static Friction of Corrugated and Solid Fiberboard” (ASTM procedure D 4521-96) and in “Standard Method for Coefficient of Static Friction of Uncoated Writing and Printing Paper by Use of the Inclined Plane Method” (ASTM procedure D 4918-97). It has been discovered that the CSF property of a polymer film surface affects the dense packing potential of a polymer coated activated carbon since the dense packing of particles requires the sliding of external surfaces of particles during a slow fill method for forming the filter bed and during a vibration method for obtaining maximum particle packing during or after forming a packed bed. A polymer with an excessively high CSF will leave a packed bed with less carbon per unit volume bed and, therefore, less volumetric capacity for contaminant removal.

The amount of emulsion solids to be applied for effectively eliminating dusting while leaving adsorptive properties unaffected will depend on the amount of external surface area to be coated, as determined by activated carbon particle size, shape, particle density, and surface roughness. The goal is to achieve an adequate coating of the external surface of a few microns in thickness. Though achieving the benefits of the coating might require a certain loading of polymer on a typical 2 mm diameter activated carbon pellet, a greater amount of coating would be required for a smaller particle size, dₚ. Basic geometry dictates that the increased amount of coating needed for a smaller particle is roughly proportional to the reciprocal of the particle size, dₚ⁻¹, with the exact amount of coating dependent on particle shape, particle density, and surface roughness. As those skilled in the art will appreciate, the desired loading range to gain the benefits of low dusting without hindering adsorptive performance, in terms of both capacity for adsorption and adsorption rate, will often best be determined by first applying an empirical method of coating a set of activated carbon samples with a range of polymer loadings. A minimum amount of coating will at least be required to make the particles essentially dust-free.

The shaped or granular active carbon material of the invention described herein may be derived from any known active carbon precursors including coal, lignocellulosic materials, including pulp and paper, residues from pulp production, wood (like wood chips, sawdust, and wood flour), nut shell (like almond shell and coconut shell), kernel, and fruit pits (like olive and cherry stones), petroleum, bone, and blood.

Gas and vapor phase streams of commercial importance that can be treated with activated carbon include: air, helium, neon, argon, krypton, xenon, hydrogen, oxygen, nitrogen, methane, natural gas, ethane, ethylene, propane, propylene, butane, carbon dioxide, syngas, carbon monoxide, ammonia, chlorofluorocarbons, chlorofluorohydrocarbons, sulfur hexafluoride and vapor spaces in contact with volatile organic compounds, such as fuel tanks of all sizes.

Liquid streams of commercial importance that are treated with activated carbon include: process water, drinking water, solutions of sugars or carbohydrates such as high fructose corn syrup, solutions obtained during the processing of sugar cane and sugar beets, fruit juices, wine, beer, malt beverages, distilled spirits such as whiskey, bourbon, vodka, scotch, and gin, petroleum distillates such as gasoline, diesel fuel, jet fuel, fuel oil and lubricating oil, propanediol, ethylene glycol, propylene glycol, lactic acid, acetic acid, citric acid, phosphoric acid, vegetable oil, glycerin, and wastewater effluents.

The following list of contaminants are among those subject to removal by the present method in the treatment of gas and vapor phase streams: acetaldehyde, acetamide, acetone, acetonitrile, acrolein, acrylamide, acrylic acid, acrylonitrile, allyl chloride, ammonia, benzene, benzotrichloride, bromoform, 1,3-butadiene, butane, carbon disulfide, carbon tetrachloride, carbonyl sulfide, chlorine, chloroacetic acid, chlorobenzene, chloroform, chloroprene, o-cresol, m-cresol, p-cresol, cumene, cyclohexane, cyclohexanone, diazomethane, 1,4-dichlorobenzene, 1,3-dichloropropene, diethanolamine, N,N-dimethylaniline, N,N-dimethylformamide, N,N-dimethylacetamide, 1,1-dimethylhydrazine, dimethyl sulfate, 1,4-dioxane, epichlorohydrin, 1,2-epoxybutane, ethanol, ethyl acrylate, ethylbenzene, ethyl carbamate, ethyl chloride, ethylene dibromide, ethylene dichloride, ethylene glycol, ethyleneimine, ethylene oxide, ethylene thiourea, ethylene dichloride, formaldehyde, gasoline vapor, hexachloroethane, hexane, hydrazine, hydrochloric acid, hydrogen fluoride, hydrogen sulfide, malodor compounds, mercaptans, mercury, methanol, methyl bromide, methyl chloride, methyl chloroform, methyl ethyl ketone, methyl hydrazine, methyl iodide, methyl isobutyl ketone, methyl methacrylate, methyl tert-butyl ether, methylene chloride, N-methyl pyrrolidinone, naphthalene, nitrobenzene, phenol, phosgene, phosphine, propylene dichloride, propylene oxide, 1,2-propyleneimine, styrene, styrene oxide, sulfur dixoide, toluene, 1,2,4-trichlorobenzene, 1,1,2-trichloroethane, trichloroethylene, triethylamine, vinyl acetate, vinyl bromide, vinyl chloride, vinylidene chloride, xylenes mixed isomers, o-xylene, m-xylene, p-xylene, and glycol ethers.

The following list of compounds are those which may be removed by the present method from liquid fluid streams: alachlor, asbestos, atrazine, bad and/or objectionable taste and odor compounds, barium, benzene, cadmium, carbofuran, carbon tetrachloride, chlordane, chloramine, chlorine, chloroform, chlorobenzene, chromium-hexavalent, chromium-trivalent, color bodies, copper, 2,4-D, dibromochloroprane, o-dichlorobenzene, p-dichlorobenzene, 1,2-dichloroethane, 1,1-dichloroethylene, cis-1,2-dichloroethylene, trans-1,2-dichloroethylene, 1,2-dichloropropane, dinoseb, endrin, ethylbenzene, ethylene dibromide, fluoride, geosmin, heptachlor (H-34 or Heptox), heptachlor epoxide, hexachlorocyclopentadiene, lead, lindane, mercury, methoxychlor, methyl tert-butyl ether (MTBE), MIB, nitrate, nitrite, pentachlorophenol, polychlorinated biphenyls (PCBs), radon, selenium, simazine, styrene, 2,4,5-TP (silvex), tetrachloroethylene, toluene, toxaphene, 1,2,4-trichlorobenzene, 1,1,1-trichloroethane, 1,1,2-trichloroethane, trichloroethylene, TTHM, xylenes mixed isomers, o-xylene, m-xylene, and p-xylene.

Color change features could be incorporated into carbon coatings to indicate when adsorptive capacity is spent so filters are used more efficiently. For example, manufacturers' recommendations for changing POU filters are usually based on either a time period of use or a volume of water treated. On-line monitoring of the effluent concentration of the filter requires electronic components that are not economically suitable for POU applications. With either the time or volumetric basis for changeout, it is difficult for users to change their filters at the point when the filter capacity has been used to maximum benefit. When filters are changed with some adsorptive capacity remaining, then users incur added expense. When filters are changed after they are saturated, breakthrough of one or more contaminant components from the filter has likely occurred. The cases of premature filter changeout and contaminant are undesirable to carbon filter users. A color-changing indicator that provides a more precise method identifying when filters should be replaced is therefore useful.

When a new carbon filter is put on-line, the concentration of a component targeted for adsorption will be low in the vicinity of the original “fresh” coating since it will be adsorbed by the activated carbon. As the activated carbon becomes saturated at the feed end of the filter, the concentration of the adsorbate in the water surrounding the “fresh” coating will increase. With a coating designed to undergo a color change triggered by the increase in concentration, a second “spent” color will develop in the filter bed. The “spent” color will develop at the feed end and move towards the product end of the filter. For example, a pigment in the coating could become bleached by free chlorine present in municipal drinking water. The opposite could occur as well, as many colorless compounds exist that can be oxidized by chlorine into chromophores. The user would replace the filter when the entire length of the filter changed from the fresh to the spent color, confident that the filter's maximum useful life has been obtained. Either the “spent” or “fresh” color could be colorless or clear. The color indicating compound could be added as a pigment to the coating or as a reactive chemical group grafted onto the coating polymer. The key feature in selecting the method of coloring is to immobilize the colorant in the coating so that it does not become an undesireable contaminant in the filter effluent and is not adsorbed into the activated carbon rather than being vsible on its external surface.

The following examples describe the method and properties of materials that have been treated.

### EXAMPLE 1

Samples of two types of MeadWestvaco wood-based activated carbon pellets, 2 mm BAX 1100 and BAX 1500, were coated with different aqueous polymer emulsions and a range of polymer loadings. The activated carbon pellets were coated by tumbling in a rotating cylinder and initially heated to 250° F. (121° C.) using a hot air gun. An emulsion of the polymer was then sprayed on the carbon in single or successive doses as the activated carbon was maintained at about 150° F. (66° C.) under the hot air flow. The solids concentrations in the spray for coating BAX 1100 were 3.4-5.8 wt % by diluting the raw emulsion with water to one-tenth of the as-received concentration. The solids concentrations in the spray for coating BAX 1500 were 8.8 wt % by diluting the raw emulsions with appropriate aliquots of water. The coated activated carbon was then dried overnight at 220° F. (105° C.). After drying, any residual dust on the pellet exterior was removed by applying the vibration and airflow treatment of the first 10-20 minutes of the dust attrition test (described below). The final coated products had a shiny, smooth appearance, compared with the dull exterior of the uncoated material.

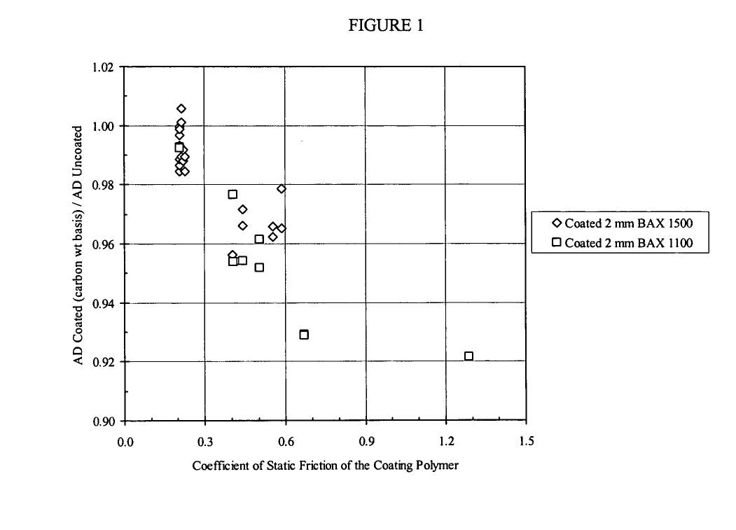

FIG. 1 and Table I show that the apparent density (AD) of the carbon pellets relative to the uncoated pellets was maintained by using a polymer with a CSF of less than 0.3. The coatings that maintained carbon content in the packed bed (Packing Ratio of 0.98+) were polyethylene films (sample runs 1-16). Polypropylene and the many evaluated forms of acrylic, butadiene, and styrene polymers, even in combination with polyethylene in some cases, reduced 20 the carbon content of the packed bed (comparative sample runs C1-C11).

TABLE I

| | | | | | | | | |
|---|---|---|---|---|---|---|---|---|
| | | | | | | B: | C: | |
| | | | | | A: | Uncoated | Coated | Packing |
| | | | Slide | | Polymer | Pellet | Pellet | Ratio |
| Run | | Grade | Angle | | Loading | AD | AD | C * (100% − A)/ |
| No. | Polymer | (source) | degrees | CSF | wt % | g/cc | g/cc | B |

Runs 1-20: 2 mm BAX 1500

| | | | | | | | | |
|---|---|---|---|---|---|---|---|---|
| 1 | Poly- | 325N35 | 11.7 | 0.21 | 1.5 | 0.281 | 0.283 | 0.993 |
| 2 | ethylene 1 | (ChemCor) | | | 1.5 | 0.282 | 0.282 | 0.984 |
| 3 | | | | | 2.0 | 0.281 | 0.286 | 1.000 |
| 4 | | | | | 2.0 | 0.281 | 0.286 | 0.997 |
| 5 | | | | | 2.0 | 0.281 | 0.283 | 0.987 |
| 6 | | | | | 3.0 | 0.281 | 0.289 | 0.999 |
| 7 | | | | | 3.0 | 0.282 | 0.288 | 0.988 |
| 8 | Poly- | 325G | 12.1 | 0.21 | 2.0 | 0.281 | 0.287 | 1.001 |
| 9 | ethylene 2 | (ChemCor) | | | 2.0 | 0.281 | 0.283 | 0.989 |
| 10 | | | | | 3.0 | 0.281 | 0.291 | 1.006 |
| 11 | Poly- | JONREZ ® | 12.5 | 0.22 | 1.5 | 0.282 | 0.283 | 0.988 |
| 12 | ethylene 3 | W-2320 | | | 3.0 | 0.282 | 0.289 | 0.992 |
| | | (Mead- | | | | | | |
| | | Westvaco) | | | | | | |
| 13 | Poly- | 330N35 | 12.9 | 0.23 | 2.0 | 0.281 | 0.283 | 0.989 |
| 14 | ethylene 4 | (ChemCor) | | | 3.0 | 0.281 | 0.285 | 0.985 |
| C1 | Acrylic | JONREZ ® | 23.8 | 0.44 | 1.5 | 0.282 | 0.277 | 0.966 |
| C2 | copolymer | E-2062 | | | 3.0 | 0.282 | 0.283 | 0.972 |
| | | (Mead- | | | | | | |
| | | Westvaco) | | | | | | |
| C3 | Poly- | 597N40 | 29.0 | 0.55 | 1.5 | 0.282 | 0.276 | 0.962 |
| C4 | propylene | (ChemCor) | | | 3.0 | 0.282 | 0.281 | 0.966 |
| C5 | Styrene | JONREZ ® | 30.4 | 0.59 | 1.5 | 0.281 | 0.279 | 0.979 |
| C6 | Acrylic | E-2069 | | | 3.0 | 0.281 | 0.279 | 0.965 |
| | copolymer | (Mead- | | | | | | |
| | | Westvaco) | | | | | | |

Runs 21-27: 2 mm BAX 1100

| | | | | | | | | |
|---|---|---|---|---|---|---|---|---|
| 15 | Poly- | 325N35 | 11.7 | 0.21 | 1.6 | 0.353 | 0.356 | 0.993 |
| 16 | ethylene 1 | (ChemCor) | | | 2.9 | 0.353 | 0.361 | 0.992 |
| C7 | Poly- | SM2059 | 22.1 | 0.41 | 2.3 | 0.353 | 0.353 | 0.977 |
| | siloxane | (GE | | | | | | |
| | | Silicones) | | | | | | |
| C8 | Poly- | 43N40 | 26.8 | 0.51 | 3.0 | 0.353 | 0.350 | 0.961 |
| | propylene | (ChemCor) | | | | | | |
| C9 | Poly- | WE4-25A | 33.8 | 0.67 | 1.9 | 0.353 | 0.335 | 0.929 |
| C10 | ethylene/ | (ChemCor) | | | 2.8 | 0.353 | 0.338 | 0.929 |
| | acrylic acid | | | | | | | |
| C11 | Styrene | CP620NA | 52.2 | 1.29 | 1.9 | 0.353 | 0.332 | 0.922 |
| | butadiene | (Dow Chem) | | | | | | |

The apparent densities were measured by slow 0.75-1.0 sec/cc fill of 150 mL of activated carbon particles into a 250 mL glass graduated cylinder. The Packing Ratio was the amount of activated carbon in a packed bed volume of coated pellets relative to the amount of activated carbon in a packed bed of uncoated pellets, equal to the ratio of the activated carbon weight-basis AD for the coated pellets and the uncoated pellet AD. The carbon weight-basis density for the coated pellets was the product of the coated pellet AD multiplied by the weight percent original activated carbon in the pellet (100%-wt % polymer loading). CSF properties of the coating polymer films were measured by preparing 0.003″ thick draw-downs of emulsions containing 9 wt % solids on Form 2C opacity paper (The Leneta Co.), and by then drying at 105° C. A 752 gram slide weight with a draw-down coated opacity sheet attached to its underside was placed over a complementary coated opacity sheet attached to the incline table. The angle of inclination under which movement of the slide initiated was measured, with the average of five angle values reported for each type of polymer (reported as the “Slide Angle”).

Tables II and III compare the dusting attrition properties for uncoated and coated pellets. Dust attrition rates were measured with the two-point method in a 30-minute test (described below).

Initial dust and dust rate values were measured by a modified, 3-filter version of the “Standard Test Method for Dusting Attrition of Granular Carbon” (ASTM D5159-91). A 1.0 dL sample of carbon is placed on a screen with 0.250 mm openings in a test cell holder and is subjected to vibration of 40 m/s/s RMS acceleration and downward air flow of 7.0 L/min for a 10 minute interval. A glass fiber filter, placed below the sample screen, collects dust from the sample. The vibration and airflow step is conducted three times with three different filters.

TABLE II

| | | | | Initial | Dust | |
|---|---|---|---|---|---|---|
| Run | | | Polymer | Dust | Rate | |
| No. | Polymer | CSF | Loading | mg per | mg per | Packing |
| Coated 2 mm BAX 1500 | | | wt % | dL | min | Ratio |
| Uncoated 1500 (C12): AD = 0.281 g/cc | | | | 3.4 | 0.20 | 1.000 |
| Uncoated 1500 (C13): AD = 0.282 g/cc | | | | 2.8 | 0.13 | |
| C14 | Poly- | 0.21 | 0.5 | 1.7 | 0.08 | 0.994 |
| 17 | ethylene 1 | | 1.0 | 0.0 | 0.04 | 0.993 |
| 1 | | | 1.5 | 0.9 | 0.04 | 0.993 |
| 2 | | | 1.5 | 0.8 | 0.03 | 0.984 |
| 3 | | | 2.0 | 1.4 | 0.03 | 1.000 |
| 4 | | | 2.0 | 1.1 | 0.03 | 0.997 |
| 5 | | | 2.0 | 0.9 | 0.02 | 0.987 |
| 6 | | | 3.0 | 1.1 | 0.04 | 0.999 |
| 7 | | | 3.0 | 0.3 | 0.02 | 0.988 |
| C15 | Poly- | 0.21 | 0.5 | 0.5 | 0.07 | 1.007 |
| C16 | ethylene 2 | | 1.0 | 1.4 | 0.07 | 0.996 |
| 8 | | | 2.0 | 1.1 | 0.02 | 1.001 |
| 9 | | | 2.0 | 0.3 | 0.00 | 0.989 |
| 10 | | | 3.0 | 0.0 | 0.03 | 1.006 |
| C17 | Poly- | 0.22 | 0.5 | 1.1 | 0.07 | 0.981 |
| 11 | ethylene 3 | | 1.5 | 0.9 | 0.01 | 0.988 |
| 12 | | | 3.0 | 0.8 | 0.00 | 0.992 |
| C18 | Poly- | 0.23 | 0.5 | 1.7 | 0.07 | 1.000 |
| C19 | ethylene 4 | | 1.0 | 1.1 | 0.07 | 0.988 |
| 13 | | | 2.0 | 1.4 | 0.01 | 0.989 |
| 14 | | | 3.0 | 0.3 | 0.02 | 0.985 |
| C20 | Acrylic | 0.44 | 0.5 | 1.0 | 0.15 | 0.973 |
| C1 | copolymer | | 1.5 | 1.9 | 0.01 | 0.966 |
| C2 | | | 3.0 | 1.3 | 0.00 | 0.972 |
| C21 | Poly- | 0.55 | 0.5 | 1.7 | 0.07 | 0.969 |
| C4 | propylene | | 1.5 | 2.5 | 0.00 | 0.962 |
| C5 | | | 3.0 | 0.7 | 0.01 | 0.966 |
| C22 | Styrene | 0.59 | 0.5 | 1.6 | 0.12 | 0.984 |
| C5 | Acrylic | | 1.5 | 0.6 | 0.02 | 0.979 |
| C6 | copolymer | | 3.0 | 0.7 | 0.00 | 0.965 |

The dust rate is calculated by the following equation:
Dust Rate (mg/min/dL), DR=0.0732 w₃

where w₃ is the milligram weight gain of the third filter.

TABLE III

| | | | | Initial | Dust | |
|---|---|---|---|---|---|---|
| Run | | | Polymer | Dust | Rate | |
| No. | Polymer | CSF | Loading | mg per | mg per | Packing |
| Runs 1-21: 2 mm BAX 1100 | | | wt % | dL | min | Ratio |
| Uncoated sample (C23): AD = 0.353 g/cc | | | | 11.4 | 0.69 | 1.000 |
| 15 | Poly- | 0.21 | 1.6 | 2.2 | 0.00 | 0.993 |
| 16 | ethylene 1 | | 2.9 | 1.9 | 0.00 | 0.992 |
| C7 | Poly- | 0.41 | 2.3 | 0.0 | 0.04 | 0.977 |
| | siloxane | | | | | |
| C8 | Poly- | 0.51 | 3.0 | 11.5 | 0.07 | 0.961 |
| | propylene | | | | | |
| C9 | Poly- | 0.67 | 1.9 | 8.7 | 0.13 | 0.929 |
| C10 | ethylene/ | | 2.8 | 5.4 | 0.12 | 0.929 |
| | acrylic acid | | | | | |
| C11 | Styrene | 1.29 | 1.9 | 6.2 | 0.15 | 0.922 |
| | butadiene | | | | | |

The dust rate from this equation is within a standard deviation of ±13% of the dust rate obtained by the standard ASTM procedure that uses filter weight data from three additional 10 minute test intervals.

The initial dust is calculated as the milligram weight gain for the first filter, w₁, minus the amount of dust attrited within that first 10 minutes (10×DR):
Initial Dust (mg/dL)=w₁−10 DR.

The inherent error in dust rate is ±0.01 mg/dL by a partial differential error analysis of its equation for calculation and the 0.1 mg readability of the four decimal place gram balance required in the procedure. Likewise, the inherent error in initial dust is ±0.3 mg/dL. Therefore, the non-detect dust rate value would be 0.01 mg/min/dL and the non-detect initial dust value would be 0.3 mg/dL.

The butane activity values were determined according to the procedure described in U.S. Pat. No. 5,204,310 and such teaching is incorporated by reference herein.

The data in Tables II show that polymer loadings of greater than 1.5 wt % were necessary with 2 mm pellets to consistently reduce dusting rates to a low level of less than 0.03 mg/min for the 1.0 dL test samples, or about a three-quarters or greater reduction in dusting rate compared with the uncoated pellets (C12 and C13). When polymer loadings were below 1.5 wt %, the benefits of the coating to reduce dust rates were diminished (comparative sample runs C14-C22). The data in Table HI show that reductions in dust rates for 2 mm BAX 1100 were greatest for the polyethylene and polysiloxane coatings, with 94% or greater reductions in dusting rate. The other coatings reduced dusting rate by 79-90% (comparative sample runs C8-C11). However, for the samples shown in Table III, the combination of low dusting rate and maintained packing density of activated carbon in a bed were both attained by the activated carbon samples coated with the low CSF polymer, polyethylene (sample runs 15 and 16).

The data in Table IV shows that, as a result of the coatings, weight-basis capacity or activity of the BAX 1100 pellets for adsorption of 100% butane vapors at 25° C. was only modestly affected by the coatings, as expected from prior art teachings for acrylic- and styrene-based coatings (e.g, U.S. Pat. No. 4,476,169). However, when considered on a volume-packed bed basis of adsorptive capacity, as might be important for a packed bed filter, the polyethylene coated pellets (runs 15 and 16), had nearly unaffected adsorption capacity for butane vapors, but the polypropylene, polyethylene/acrylic acid, and the styrene butadiene coated pellets (comparative runs C7-C11) had notably diminished volumetric adsorption (diminished volume-basis activity ratio). The diminished volumetric adsorption performance was a direct consequence of the low activated carbon content in the packed bed (low packing ratio) attributed to the high CSF 5 properties of the coating polymer. Therefore, the superior coated carbon was the polyethylene coated activated carbon which, at a sufficient loading of polymer film, had low dusting properties, plus had a polymer film with a sufficiently low CSF so that, compared with the uncoated pellets, the same amount of carbon could be packed in a bed and available for adsorption on a volume-bed basis.

TABLE IV

| | | | | | | Volume- | |
|---|---|---|---|---|---|---|---|
| | | | | Weight- | Volume- | Basis | |
| | | | | Basis | Basis | Activity | |
| | | | | Butane | Butane | Ratio | |
| Run | Coating | | | Activity | Activity | Coated | |
| No. | Polymer | CSF | Polymer | g-C4 per | g-C4 per | Activity/ | |
| Runs 1-21: | | | Loading | 100 g- | dL-pellet | Uncoated | Packing |
| 2 mm BAX 1100 | | | wt % | pellets | bed | Activity | Ratio |
| Uncoated sample (C23): AD = 0.353 g/cc | | | | 34.6 | 12.2 | 1.000 | 1.000 |
| 15 | Poly- | 0.21 | 1.6 | 33.7 | 12.0 | 0.98 | 0.993 |
| 16 | ethylene 1 | | 2.9 | 33.0 | 11.9 | 0.98 | 0.992 |
| C7 | Poly- | 0.41 | 2.3 | 33.4 | 11.8 | 0.97 | 0.977 |
| | siloxane | | | | | | |
| C8 | Poly- | 0.51 | 3.0 | 32.8 | 11.5 | 0.94 | 0.961 |
| | propylene | | | | | | |
| C9 | Poly- | 0.67 | 1.9 | 33.6 | 11.4 | 0.93 | 0.929 |
| C10 | ethylene/ | | 2.8 | 33.5 | 11.2 | 0.92 | 0.929 |
| | acrylic acid | | | | | | |
| C11 | Styrene | 1.29 | 1.9 | 34.3 | 11.4 | 0.93 | 0.922 |
| | butadiene | | | | | | |

### EXAMPLE 2

Samples of MeadWestvaco wood-based activated carbon pellets, 2 mm BAX 1100, were coated with different aqueous polymer emulsions to polymer loadings of 2 wt % emulsion solids on the activated carbon in order to demonstrate the effects of polymer selection on the dynamic transport of contaminant across the coating films. The activated carbon pellets were coated by tumbling in a rotating cylinder. An emulsion of the polymer was sprayed on the carbon in a single dose with the activated carbon at ambient temperature. The solids concentrations in the spray for coating BAX 1100 was 8.8 wt % by diluting the raw emulsions with appropriate aliquots of water. The coated activated carbons were then dried for 16 hours at 220° F. (105° C.). The final coated products had a shiny, smooth appearance, compared with the dull exterior of the uncoated material.

Table V shows that all of the coated pellets in this grouping had low dusting rates, as expected. However, the coating consisting of the low CSF polymer, polyethylene, had a carbon content in packed beds that was actually even slightly higher than the uncoated pellets (packing ratios above 1.00), whereas the other coating polymers with higher CSF properties gave diminished activated carbon content in packed beds. Two methods of measuring apparent densities were used. The standard method of a slow fill rate of carbon particles into a graduated cylinder was used (“Slow-Fill AD”), as employed in Example 1, plus an alternative vibrated bed method was used for packing a bed (“Vibrated AD”). The vibrated AD method was similar to the type of vibration method used in quickly forming commercial packed bed filters, and experimentally consisted of subjecting a quickly filled, loosely packed 170 mL bed in a 250 mL graduated cylinder to a variable amplitude of vibration (1-6 G variations in irregular 1-3 sec frequencies of peak-to-trough of vibrational G-force applied, using the vibrating table in the ASTM procedure D5159-91).

TABLE V

| | Uncoated | | | |
|---|---|---|---|---|
| | BAX 1100 (C24) | Run 18 | Run C25 | Run C26 |
| Coating | | Poly- | Acrylonitrile | Styrene |
| Polymer | | ethylene 2 | Butadiene | Butadiene |
| Polymer | — | 325G | HYCAR | CP620NA |
| Grade | | (ChemCor) | 1572X64 | (Dow Chem) |
| (source) | | | (Noveon) | |
| Slide | — | 12.1° | 74.0° | 52.2° |
| Angle | | | | |
| CSF | — | 0.21 | 3.49 | 1.29 |
| Polymer | 0 | 2.0 | 2.0 | 2.0 |
| Loading, | | | | |
| wt % | | | | |
| Slow-Fill | 0.358 | 0.372 | 0.330 | 0.358 |
| AD, g/cc | | | | |
| Slow-Fill | 1.000 | 1.019 | 0.905 | 0.980 |
| Packing | | | | |
| Ratio | | | | |
| Vibrated | 0.363 | 0.374 | 0.331 | 0.360 |
| AD, g/cc | | | | |
| Vibrated | 1.000 | 1.010 | 0.894 | 0.974 |
| Packing | | | | |
| Ratio | | | | |
| Initial | 11.6 | 1.6 | 0.7 | 0.6 |
| Dust, | | | | |
| mg/dL | | | | |
| Dust Rate, | 0.74 | 0.03 | 0.02 | 0.01 |
| mg/min | | | | |

The purpose of the vibration method was to determine if sliding of particles within the bed and tighter packing could be induced for particles coated with high CSF polymer 10 films (comparative runs C25 and C26), as a potential means to overcome the looser, low carbon content packing demonstrated by the slow fill method. As shown in Table V, the results for packing ratios were essentially the same by either packed bed forming method, with superior carbon content achieved with the activated carbon particles coated with a low CSF polymer, in this case, a polyethylene (run 18). Therefore, the poor packing ratios of the samples coated with high CSF polymers were not overcome by the alternative means of bed packing.

The data in Table VI demonstrate that the volume-basis adsorption capacity of coated activated carbon particles was maintained or diminished according to the CSF of the polymer film and its effects on the carbon content in the packed bed, and that, furthermore, the dynamic transport of vapors across the coating film was strongly affected by the selection of the polymer. As shown in Table VI and expected from prior art for styrene and acrylonitrile polymer coatings applied to activated carbon by a similar method (U.S. Pat. No. 4,476,169), the weight-basis adsorption capacities for 100% butane vapors (25° C.) were not distinctively different for the different coated samples, with the styrene butadiene-coated sample having about the same weight-basis activity as the sample coated with polyethylene. However, once the apparent densities of the packed beds and the polymer loadings were factored into the packed bed performance, the volume-basis activity of the pellets coated with polyethylene (run 18) was shown to be superior to the samples coated with the acrylonitrile butadiene and styrene butadiene polymers (comparative runs C25 and C26). The volume-basis activity of the packed bed for the polyethylene coated sample was equal to that of the uncoated pellets (comparative run C24).

TABLE VI

| | Uncoated | | | |
|---|---|---|---|---|
| | BAX 1100 (C24) | Run 18 | Run C25 | Run C26 |
| Coating | | Poly- | Acrylonitrile | Styrene |
| Polymer | | ethylene 2 | Butadiene | Butadiene |
| CSF | — | 0.21 | 3.49 | 1.29 |
| Polymer | — | 2.0 | 2.0 | 2.0 |
| Loading, | | | | |
| wt % | | | | |
| Butane | 38.6 | 37.2 | 36.8 | 37.4 |
| Activity, | | | | |
| g/100 g | | | | |
| Butane | 13.8 | 13.8 | 12.2 | 13.4 |
| Activity, | | | | |
| g/dL-bed | | | | |
| BWC, g/dL | 11.8 | 11.8 | 9.4 | 10.4 |
| Butane | 0.855 | 0.852 | 0.769 | 0.780 |
| Ratio | | | | |
| <18 Å | 54 | 55 | 49 | 53 |
| pores, | | | | |
| cc/L-bed | | | | |
| 18-50 Å | 197 | 196 | 175 | 193 |
| pores, | | | | |
| cc/L-bed | | | | |
| Total <50 Å | 251 | 251 | 224 | 245 |
| pores, | | | | |
| cc/L-bed | | | | |
| Ratio | 0.784 | 0.781 | 0.783 | 0.785 |
| 18-50 Å/ | | | | |
| <50 Å | | | | |
| pores | | | | |

The data in Tables VI are especially important for demonstrating the further advantage of the polyethylene coatings in not hindering dynamic transport of contaminants in addition to the benefits in particle packing from the low CSF properties. The butane working capacity, BWC, was measured according to the procedure described in U.S. Pat. No. 5,204,310 which involves subjecting a small bed of activated carbon to a clean air purge of about 600 bed volumes subsequent to the equilibrium saturation of the sample with 100% butane vapors at 25° C. The pore size and volume data were measured by the procedure described in U.S. Pat. No. 5,204,310. The BWC value is an accepted surrogate measure of working capacity performance of activated carbons for evaporative emission control canisters, and is related to the volume of small mesopores in the range of 18-50 Å size, as taught in U.S. Pat. No. 5,204,310, whereas total butane adsorption is related to the total amount of pores <50 Å in size. Smaller size pores, <18 Å, are strongly adsorbing and contribute to equilibrium adsorption but are not readily purgeable under the conditions of the test. Butane Ratio is defined as the proportion of the total butane that is purgeable (volume-basis butane activity divided by BWC) and, by extension, is related to the proportion of total pores less than 50 Å in size that are 18-50 Å in size which adsorb vapors with only moderate strength. Note that the BWC value is not an equilibrium property since, despite being related to the pore volume and pore size distribution of the activated carbon, hindered transport of vapors from the interior of activated carbon particle has the potential to reduce the removal of butane into the purge stream.

As shown in Table VI, the magnitude of purged butane (BWC) and the butane puregability (butane ratio) of the polyethylene-coated sample (run 18) are the same as that of the uncoated pellets (run C24), but there is a sharp reduction in BWC and butane purgeability of the butadiene polymer-coated samples (Runs C25 and C26), beyond the relative reduction in the volume-basis BWC imposed by the lower activated carbon packing density for these two samples. Since the ratios of 18-50 Å pores relative to total <50 Å pores are the same for all the samples, the diminished purgeability (butane ratio) of the butadiene polymer-coated samples is therefore attributed to transport resistance across the film and is not from differences in the porosity properties of the core activated carbon. Therefore, though equilibrium adsorption properties of the acrylonitrile and styrene butadiene-coated samples are diminished by reductions in activated carbon packing densities, the BWC test provides proof that these butadiene-based polymers are inferior to a polyethylene coating under filtering conditions where dynamic transport of contaminants across the coating film is encountered. While these differences in packing density and transport rates by the butadiene-based coatings might be less important for a static fluid and possibly loose-fill application, such as the method for reducing dew points of contaminants in a multipane windows as taught in U.S. Pat. No. 4,476,169, other packed bed filter applications for treatment of vapors and liquids will find the method of maintaining activated carbon packing density by selecting polymer coatings with low CSF properties and choosing a coating polymer with low hindrance to contaminant transport rates, such as demonstrated with polyethylene, to be very useful.

### EXAMPLE 3

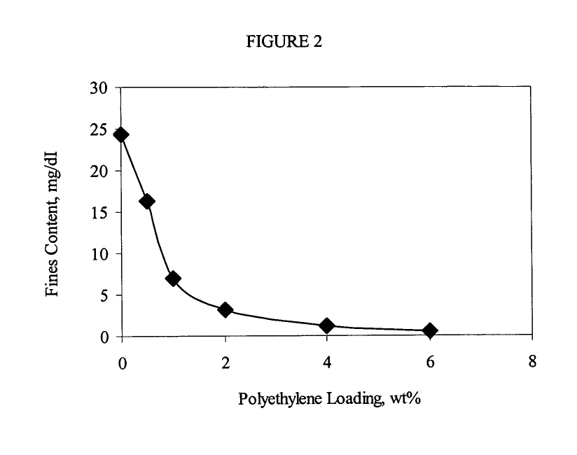

Samples of MeadWestvaco wood-based activated granular carbon, RGC 40, a commercial grade activated carbon commonly used for water filtration and liquid phase purification, were sieved to 10×20 mesh and then coated with polyethylene emulsion (ChemCor 325N35) according to the method described in Example 2. As the polyethylene coating on 10×20mesh RGC was increased, the amount of dust that transferred from the carbon to water decreased from 24.3 mg/dL to as low as 0.5 mg/dL, as shown in FIG. 2 and Table VII. In order to test for fines in a manner closer to a water filtration application, the concentration of dust or fines in water was quantified by swirling 5.0 grams of samples of activated carbon in 50.0 mL of filtered eater and then measuring the transmittance of a liquid aliquot at a wavelength of 440 nm with a spectorophotometer. A calibration between transmittance and dust concentration was made using water slurries containing known concentrations of carbon fines. Carbon fines for calibration were formed by milling the uncoated RGC carbon in a SPEX CertiPrep shaker ball mill for one minute.

TABLE VII

| | Polymer | Fines | |
|---|---|---|---|
| | Loading, | Content, | Fines Reduction |
| Run No. | wt % | mg/dL-bed | vs. Uncoated |
| C27 | Uncoated | 24.3 | — |
| | RGC 40 | | |
| C28 | 0.5 | 16.3 | −33% |
| 19 | 1 | 7.0 | −71% |
| 20 | 2 | 3.2 | −87% |
| 21 | 4 | 1.2 | −95% |
| 22 | 6 | 0.5 | −98% |

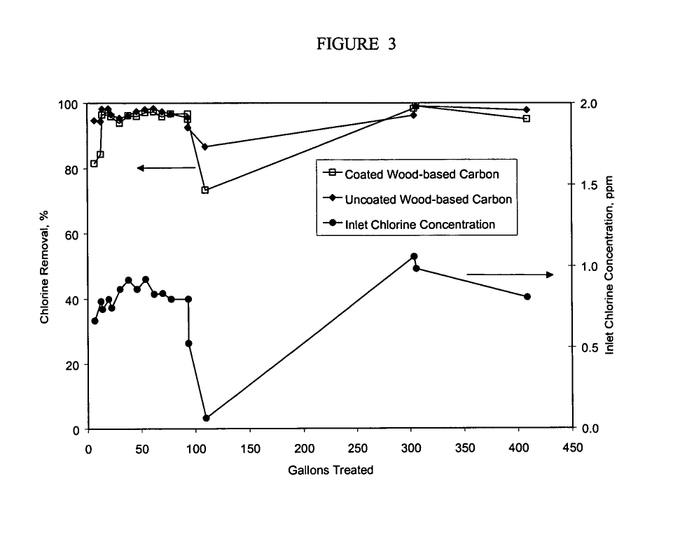

Uncoated wood-based activated carbon (comparative run C27) and the same carbon material coated with 2 wt % polyethylene (run 20) had little to no difference in chlorine removal performance in a packed bed, as shown in FIG. 3. The 2 wt % coated carbon had a fines content of 3.2 mg/dL, compared to the 24.3 mg/dL in the uncoated carbon, an 87% reduction in fines content from the coating. After each carbon treated 425 gallons of water, chlorine removal by the uncoated and coated carbon remained above 95%. The measurements were made by preparing two columns, 12 inches long and 1 inch in diameter containing about 50 grams of 10×20 mesh carbon and packed by a slow-fill method, and testing in parallel at flow rates of 500 min through each column. Bleach (6% solution of sodium hypochlorite) was injected at a rate of 1 ml/hr into deionized water to create a feed having about 1 ppm free chlorine. Deionized water was used to avoid forming chloramines, which results when bleach is added to tap water containing nitrogen compounds.

### EXAMPLE 4

Granular carbons were coating with spray emulsions containing pigments in order to demonstrate the preparation of color coated carbons with reduced dusting. The coating method of Example 3 was used with MeadWestvaco RGC 40 wood-based activated carbon, and with the addition of dispersing the color pigment powders in the spray emulsion. The pigments were pearlescent Afflair-grade powders from EM Industries. Table VIII shows the creation of color coated carbon by the use of pigments in the coatings and the reduction of the dust or fines content compared with uncoated carbon, despite the addition of the fine powder pigment in the spray coating. Experiments failed to make coated activated carbons with red or yellow colors by the method of adding red or yellow water soluble dyes (McCormick & Co., Inc.; FD&C Yellow 5 and Red 3 & 40 food dyes) by using the same volumetric proportions of pigments to emulsion solids in the spray as the samples in Table VIII (i.e., the same volumetric content of colorant in the spray according to the differences in specific gravities of the dyes and pigments), and by using variations in the coating methods, including spraying the emulsion and dye mixture directly on activated carbon, pre-wetting the carbon with water, pre-coating the carbon with a silver color pigment, and co-mixing silver color pigment and dye in the spray emulsion. The intended purpose of the alternative methods of pre-coating with pigment or adding pigment with the dye in the spray was to establish a background silver color upon which the dye might be visible when present in an exterior coating. The intended purpose of pre-wetting the activated carbon was to prevent bulk transport of the dye-containing spray into the carbon's porosity. However, the dyes were not visible on the exterior coatings despite the presence of the red or yellow dye in the spray and despite any of the variations in the coating methods. When the treated activated carbons were dried and then placed in water, the dyes leached from the carbon and discolored the water, indicating that the dyes had indeed contacted the carbon but yet were immediately absorbed. Therefore, it was proven that a water insoluble pigment is needed to provide a color coated carbon, especially in liquid or water filtration applications for coated carbon where the leaching of a dye would be particularly undesirable if a water soluble dye was alternatively attempted for coloring the activated carbon.

TABLE VIII

| | | | | | Fines | Fines |
|---|---|---|---|---|---|---|
| | Polymer | Pigment | | | Content, | Reduction |
| Run | Loading, | Loading, | Pigment | Carbon | mg/ | vs. |
| No. | wt % | wt % | Grade | Color | dL-bed | Uncoated |
| C27 | Uncoated | | — | dull | 24.3 | — |
| | RGC 40 | | | black | | |
| 23 | 3.5 | 2.7 | Afflair | shiny | 3.9 | −84% |
| | | | 500 | gold | | |
| 24 | 3.5 | 2.7 | Afflair | shiny | 3.6 | −85% |
| | | | 119 | silver | | |
| 25 | 3.5 | 2.7 | Afflair | shiny | 4.3 | −82% |
| | | | 351 | yellow | | |
| 26 | 3.5 | 2.7 | Afflair | shiny | 6.8 | −72% |
| | | | 235 | green | | |
| 27 | 3.5 | 2.7 | Afflair | shiny | 6.9 | −72% |
| | | | 219 | purple | | |

### EXAMPLE 5

Color coated carbons were prepared to demonstrate the preparation of attractive color coated carbons with reduced dusting, and with the packing density of activated carbon and the dynamic transport properties of contaminant unhindered by the presence of the coating. The coating method of Example 1 was used with MeadWestvaco 2 mm BAX 1500 wood-based activated carbon pellets, with the addition of dispersing the color pigment powders in the spray emulsion and with the polyethylene emulsion solids at a concentration of 9 wt % in the spray. The aqueous spray emulsion contained 325N35 polyethylene (ChemCor). The pigments were pearlescent Afflair-grade powders from EM Industries. A top coating containing 1 wt % each, on a coated carbon basis, of polyethylene emulsion solids and a phthalocyanine blue dispersed pigment (Drew Graphics, Liquiflex blue BR-2025 dispersion) was applied in making Run 28 after a initial coating was applied containing 1 wt % each, on coated carbon basis, of the polyethylene emulsion solids and the silver pearlescent pigment (Afflair 103).

As shown in Table IX, the visible and attractive color feature of the coating was attained by the color coated activated carbons with the full benefits of the low dusting rate from the coating, without reducing activated carbon density in the packed bed, and without hindering vapor transport across the film, as shown by the same butane ratio values for the uncoated pellets, the polyethylene coated pellets made without pigment, and the pellets coated with polyethylene emulsion and colorants selected from the group of pigment powders and a pigment dispersion.

TABLE IX

| | Uncoated | | | | |
|---|---|---|---|---|---|
| | Pellets | | | | |
| | (C12) | Run 5 | Run 28 | Run 29 | Run 30 |
| Polymer | 0 | 2.0 | 2.0 | 1.8 | 1.8 |
| Loading, | | | | | |
| wt % | | | | | |
| Pigment | 0 | 0 | 2.0 | 1.0 | 1.0 |
| Loading, | | | | | |
| wt % | | | | | |
| Pigment | — | — | Afflair | Afflair | Afflair |
| Grade | | | 103 + BR- | 119 | 500 |
| | | | 2025 | | |
| Carbon | dull | shiny | shiny | shiny | shiny |
| Color | black | black | blue | silver | gold |
| Slow-Fill | 0.281 | 0.283 | 0.287 | 0.290 | 0.288 |
| AD, g/cc | | | | | |
| Packing | 1.000 | 0.987 | 0.981 | 1.005 | 0.999 |
| Ratio | | | | | |
| Butane | 64.8 | 62.8 | 62.6 | 61.6 | 61.7 |
| Activity, | | | | | |
| g/100 g | | | | | |
| Butane | 18.2 | 17.8 | 18.0 | 17.9 | 17.8 |
| Activity, | | | | | |
| g/dL-bed | | | | | |
| BWC, g/dL | 15.6 | 15.2 | 15.4 | 15.5 | 15.3 |
| Butane | 0.857 | 0.856 | 0.855 | 0.869 | 0.863 |
| Ratio | | | | | |
| Initial | 3.4 | 0.9 | 1.6 | 0.9 | 1.0 |
| Dust, | | | | | |
| mg/dL | | | | | |
| Dust Rate, | 0.20 | 0.02 | 0.01 | 0.00 | 0.03 |
| mg/min | | | | | |

While the preferred embodiments of the present invention have been described, it should be understood that various changes, adaptations, and modifications may be made thereto without departing from the spirit of the invention and the scope of the appended claims. It should be understood, therefore, that the invention is not to be limited to minor details of the illustrated invention shown in preferred embodiment and the figures and that variations in such minor details will be apparent to one skilled in the art. The claims, therefore, are to be accorded a range of equivalents commensurate in scope with the advances made over the art.

1. A method for capturing contaminants from a fluid stream containing same by routing said stream through a filter comprising activated carbon particles having their external surfaces coated with a continuous film of a polymer, said polymer film having a coefficient of static friction of less than 0.3 and said polymer film being operable for essentially eliminating dust attrition of the activated carbon without affecting the packing density characteristic of the particles prior to coating.

2. A method for capturing chlorine from a fluid stream containing same by routing said stream through a packed bed filter comprised of activated carbon particles coated with a low coefficient of friction polymer film prepared by coating the activated carbon particles according to the steps of:
(a) spraying an emulsion of the polymer onto exposed surfaces of the activated carbon particles while they are in a state of turbulence, and
(b) drying the coated activated carbon material.

3. The method of claim 2 comprising a further step
(c) de-dusting the dry coated activated carbon material by removing any residual dust therefrom.

4. The method of claim 2 wherein the activated carbon material is derived from a member of the group consisting of coal, lignocellulosic materials, petroleum, bone, and blood.

5. The method of claim 4 wherein the lignocellulosic materials are selected from the group consisting of including pulp, paper, residues from pulp production, wood chips, sawdust, wood flour, nut shell, kernel, and fruit pits.

6. The method of claim 2 wherein the polymer is polyethylene.

7. The method of claim 2 wherein the polymer film is a blend of polymers.

8. The method of claim 2 wherein a color pigment is added to the polymer emulsion to alter the color of the activated carbon particles.

9. The method of claim 2 wherein the particle is selected from the group consisting of pellets, spheres, and irregular-shaped granules.

10. The method of claim 1 wherein the particle is selected from the group consisting of pellets, spheres, and irregular-shaped granules.

11. The method of claim 1 wherein the polymer film contains a color pigment to alter the color of the activated carbon.

12. The method of claim 1 wherein the polymer is polyethylene.

13. The method of claim 1 wherein the polymer film is a blend of polymers.

14. The method of claim 1 wherein the activated carbon material is derived from a member of the group consisting of coal, lignocellulosic materials, petroleum, bone, and blood.

15. The method of claim 14 wherein the lignocellulosic materials are selected from the group consisting of pulp, paper, residues from pulp production, wood chips, sawdust, wood flour, nut shell, kernel, and fruit pits.

16. The method of claim 1 wherein the fluid stream is selected from the group consisting of liquid streams and gaseous and vapor streams.

17. The method of claim 16 wherein the fluid stream is liquid and the contaminants are selected from the group consisting of alachlor, asbestos, atrazine, bad and/or objectionable taste and odor compounds, barium, benzene, cadmium, carbofuran, carbon tetrachloride, chlordane, chloramine, chlorine, chloroform, chlorobenzene, chromium-hexavalent, chromium-trivalent, color bodies, copper, 2,4-D, dibromochloroprane, o-dichlorobenzene, p-dichlorobenzene, 1,2-dichloroethane, 1,1-dichloroethylene, cis-1,2-dichloroethylene, trans-1,2-dichloroethylene, 1,2-dichloropropane, dinoseb, endrin, ethylbenzene, ethylene dibromide, fluoride, geosmin, heptachlor (H-34 or Heptox), heptachlor epoxide, hexachlorocyclopentadiene, lead, lindane, mercury, methoxychlor, methyl tert-butyl ether (MTBE), MIB, nitrate, nitrite, pentachlorophenol, polychlorinated biphenyls (PCBs), radon, selenium, simazine, styrene, 2,4,5-TP (silvex), tetrachloroethylene, toluene, toxaphene, 1,2,4-trichlorobenzene, 1,1,1-trichloroethane, 1,1,2-trichloroethane, trichloroethylene, TTHM, xylenes mixed isomers, o-xylene, m-xylene, and p-xylene.

18. The method of claim 1 wherein the fluid stream is selected from the group consisting of gaseous and vapor streams.

19. The method of claim 18 wherein the fluid stream includes contaminants selected from the group consisting of acetaldehyde, acetamide, acetone, acetonitrile, acrolein, acrylamide, acrylic acid, acrylonitrile, allyl chloride, ammonia, benzene, benzotrichloride, bromoform, 1,3-butadiene, butane, carbon disulfide, carbon tetrachloride, carbonyl sulfide, chlorine, chloroacetic acid, chlorobenzene, chloroform, chloroprene, o-cresol, m-cresol, p-cresol, cumene, cyclohexane, cyclohexanone, diazomethane, 1,4-dichlorobenzene, 1,3-dichloropropene, diethanolamine, N,N-dimethylaniline, N,N-dimethylformamide, N,N-dimethylacetamide, 1,1-dimethylhydrazine, dimethyl sulfate, 1,4-dioxane, epichlorohydrin, 1,2-epoxybutane, ethanol, ethyl acrylate, ethylbenzene, ethyl carbamate, ethyl chloride, ethylene dibromide, ethylene dichloride, ethylene glycol, ethyleneimine, ethylene oxide, ethylene thiourea, ethylene dichloride, formaldehyde, gasoline vapor, hexachloroethane, hexane, hydrazine, hydrochloric acid, hydrogen fluoride, hydrogen sulfide, malodor compounds, mercaptans, mercury, methanol, methyl bromide, methyl chloride, methyl chloroform, methyl ethyl ketone, methyl hydrazine, methyl iodide, methyl isobutyl ketone, methyl methacrylate, methyl tert-butyl ether, methylene chloride, N-methyl pyrrolidinone, naphthalene, nitrobenzene, phenol, phosgene, phosphine, propylene dichloride, propylene oxide, 1,2-propyleneimine, styrene, styrene oxide, sulfur dixoide, toluene, 1,2,4-trichlorobenzene, 1,1,2-trichloroethane, trichloroethylene, triethylamine, vinyl acetate, vinyl bromide, vinyl chloride, vinylidene chloride, xylenes mixed isomers, o-xylene, m-xylene, p-xylene, and glycol ethers.

20. A filter for removing contaminants from contaminant-containing fluid streams comprising activated carbon particles having their external surfaces coated with a continuous film of a polymer, said polymer film having a coefficient of static friction of less than 0.3 and said polymer film being operable for essentially eliminating dust attrition of the activated carbon without affecting the packing density characteristic of the particles prior to coating.
